(19) United States
(12) Patent Application Publication
(10) Pub. No.: US 2025/0379917 A1
(43) Pub. Date: Dec. 11, 2025

(54) ASSET ORCHESTRATION FOR COMMUNICATION SESSIONS

(71) Applicant: Apple Inc., Cupertino, CA (US)

(72) Inventors: Kaushik Kasi, Dublin, CA (US); David K Wong, San Mateo, CA (US); Hayden James Barsotti, Mountain View, CA (US); Harris W Christiansen, San Jose, CA (US); Christopher M Garrido, Santa Clara, CA (US); Dazhong Zhang, Saratoga, CA (US); Jinbo Qiu, San Jose, CA (US); Karthick Santhanam, Campbell, CA (US); Lee Y Ho, Mountain View, CA (US); Nicolas Wagner, San Francisco, CA (US); Wan Ru Hua, Sunnyvale, CA (US)

(21) Appl. No.: 19/227,390

(22) Filed: Jun. 3, 2025

Related U.S. Application Data
(60) Provisional application No. 63/657,578, filed on Jun. 7, 2024.

(51) Int. Cl. H04L 67/55; G06T 17/00; H04L 9/40; H04L 69/28

(52) U.S. Cl. CPC H04L 67/55; H04L 63/0428; H04L 69/28; G06T 17/00

(57) ABSTRACT

Various implementations provide a method for receiving and decrypting an asset to provide a view of a three-dimensional (3D) representation of another based on the asset. For example, a method may include prior to a communication session with a second device, receiving, from an information system (e.g., a communication session server), an encrypted asset (e.g., a 3D avatar or data associated with the 3D avatar) associated with a 3D representation of a second user. The method may further include in response to determining to initiate the communication session with the second user (e.g., on a second device), obtaining an encryption key from the information system. The method may further include providing a view of the 3D representation of the second user during the communication session based on decrypting the asset using the encryption key, the 3D representation of the second user being generated based at least on the asset.

### CROSS-REFERENCE TO RELATED APPLICATIONS

This application claims the benefit of U.S. Provisional Application Ser. No. 63/657,578 filed Jun. 7, 2024, which is incorporated herein in its entirety.

### TECHNICAL FIELD

The present disclosure generally relates to electronic devices that provide views of multi-user environments, including views that include representations of users that are shared based on obtained assets.

### BACKGROUND

Electronic devices apply user representation techniques (e.g., generating avatars) to provide various benefits to their users. For example, electronic devices may generate and present a user representation for another person, such as within extended reality (XR) environments provided during communication sessions. However, because of the size of the user representation data (e.g., three-dimensional (3D) avatars) existing user representation techniques may be insufficient in various respects such as noticeable delays when initiating a communication session.

### SUMMARY

Various implementations disclosed herein include devices, systems, and methods that provide a depiction or augmentation of a second user within a multi-user 3D environment such as an extended reality (XR) environment provided during a communication session based on receiving (e.g., downloading) an asset associated with the depiction or augmentation of the second user. In various implementations, a first device of a first user receives (e.g., pre-downloads) a three-dimensional (3D) asset of a second user to be depicted in a view at the first device during one or more communication sessions with the second user. Pre-downloading may avoid a noticeable delay when initiating a communication session by avoiding the on-call download of a 3D asset of the other user (e.g., download avatar enrollment data which may be a large data set).

In some implementations, the pre-downloading may be performed with safeguards that preserve user privacy. For example, a pre-downloaded asset may be encrypted in such a way that it is only usable (decrypted) during an approved communication session with the associated user. Determining to pre-download an avatar may be based on several factors, e.g., a contact list, previous communication sessions (e.g., call history), an enrollment trigger, push notifications, current system traffic/load, and the like. In some implementations, there may be more than one 3D asset to download for another user based on context (e.g., a work avatar vs. a personal avatar).

In some implementations, bandwidth allocation may be modified between two or more data streams associated with generating a 3D asset (e.g., an avatar) and providing a view of the 3D asset during a communication session. The data streams may include face texture data for updating the 3D asset during a live communication session, body tracking data, audio data, device data (e.g., screen bitrate), network traffic, motion detection, and the like. For example, each data stream quality may be monitored and individually modified to provide a higher quality view of the 3D asset during the communication session.

Certain implementations herein pertain to preserving a first user's privacy in generating his or her user representation in a multi-user 3D environment, such as within a chat room within an XR environment (e.g., in a physical environment via pass through video, in a virtual room, or in a combination of both). The first user may be enabled to set a privacy option to control who or what device is able to generate a user representation (e.g., automatic user preference settings). Additionally, or alternatively, the first user may be able to provide consent in response to notifications to ensure that a user representation for the first user is only provided if the first user consents.

In general, one innovative aspect of the subject matter described in this specification can be embodied in methods, at a first device having a processor and operated by a first user, that include the actions of prior to a communication session with a second device, receiving, from an information system, an asset associated with a three-dimensional (3D) representation of a second user, wherein the asset is encrypted. The actions further include in response to determining to initiate the communication session with the second user, obtaining an encryption key from the information system. The actions further include providing a view of the 3D representation of the second user during the communication session based on decrypting the asset using the encryption key, wherein the 3D representation of the second user is generated based at least on the asset.

These and other embodiments can each optionally include one or more of the following features.

In some aspects, receiving the asset is in response to identifying a trigger event associated with the first device, the second device, the information system, or a combination thereof. In some aspects, the trigger event is based on at least one of: an enrollment of the asset at the second device or the information system; a contact list associated with the first device or the second device; a push notification to the first device from the information system; a scheduled event associated with the first device or the second device; a previous communication session between the first device and the second device; system or network traffic associated with the communication session; and a request from the first device to obtain the asset.

In some aspects, receiving the asset is in response to determining that an expiration date associated with the asset has expired or the asset has been removed from the first device. In some aspects, after receiving the asset, the asset is stored at the first device for a threshold amount of time.

In some aspects, the encryption key includes an encryption token that corresponds to decrypting the asset that is associated with the 3D representation of the second user. In some aspects, the asset is a first asset, wherein when the first device receives the first asset, the first device receives a second asset associated with the 3D representation of a second user, and wherein the first asset is different than the second asset.

In some aspects, providing the view of the 3D representation of the second user is based on determining whether to generate the 3D representation of the second user using the first asset or using the second asset.

In some aspects, the actions further include updating the view of the 3D representation of the second user based on modifying bandwidth allocation between two or more data streams associated with the communication session. In some aspects, the two or more data streams associated with the communication session are based on face texture data, body data, microphone data, audio data, screen quality data, or a combination thereof.

In some aspects, the view of the 3D representation of the second user is updated during the communication session based on receiving first set of data associated with a first portion of the second user and receiving second set of data associated with a second portion of the second user, wherein the first portion is different than the second portion.

In some aspects, the actions further include determining whether there is motion associated with the first portion or the second portion of the second user during the communication session, and in response to detecting motion with the first portion of the second user, modifying bandwidth allocation between the first set of data and the second set of data. In some aspects, the actions further include receiving, from the information system, a determination whether the second user provides user consent to the receiving the asset associated with the second user at the first device.

In some aspects, the user consent is a particular type of the asset or asset preference setting. In some aspects, the information system determines that the second user provides user consent to receiving the asset associated with the second user at the first device based on receiving, at the first device via the information system, an affirmative response from the second user to a consent request.

In some aspects, the information system determines that the second user provides user consent to the receiving the asset associated with the second user at the first device based on determining that a privacy setting associated with the second user allows providing the asset of the second user to the first user. In some aspects, the information system determines that the second user provides user consent to receiving the asset associated with the second user at the first device based on determining that the first user operating the first device was previously identified by the second user to have consent to the asset and/or asset preference setting.

In some aspects, the information system is configured to identify the first device based on at least one of position data, an account associated with the first device, and assets associated with the account. In some aspects, the information system acquires the asset associated with the second user from the second device.

In some aspects, the asset associated with the second user from the second device is acquired anonymously based on tokenization protocols.

In some aspects, providing the view of the 3D representation of the second user during the communication session includes determining whether to use the asset based on a determined context associated with an environment of the first device or the second device.

In some aspects, the actions further include providing a notification to the second device based on receiving the asset associated with the second user at the first device.

In some aspects, the information system is located at the first device. In some aspects, the information system is a server external to the first device. In some aspects, the view of the 3D representation of the second user during the communication session includes a view of a 3D environment.

In some aspects, the 3D environment includes an extended reality (XR) environment. In some aspects, the first device or the second device is a head-mounted device (HMD).

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is an example of multiple devices used within a physical environment and in communication with an information system, in accordance with some implementations.

FIG. 2 illustrates an example of generating a user representation in accordance with some implementations.

FIG. 3 illustrates exemplary electronic devices operating in different physical environments during a communication session of a first user at a first device and a second user at a second device with a view of a three-dimensional (3D) representation of the second user for the first device, in accordance with some implementations.

FIG. 4A illustrates exemplary electronic devices operating in the same physical environment during a communication session with a view for a first device of a first user that includes a user representation of a second user within an extended reality (XR) environment, in accordance with some implementations.

FIG. 4B illustrates exemplary electronic devices operating in the same physical environment during a communication session with a view for a second device of a second user that includes a consent approval for a user representation of the second user for a view for the first user of FIG. 4A, in accordance with some implementations.

FIG. 4C illustrates exemplary electronic devices operating in the same physical environment during a communication session with a view for the first device of the first user that includes a user representation of the second user that the second user consented to in FIG. 4B, in accordance with some implementations.

FIGS. 5A and 5B illustrate an example of modifying bandwidth allocation associated with a user representation during a communication session in accordance with some implementations.

FIG. 6 illustrates an environment for implementing a process for receiving and decrypting an asset to provide a view of a 3D representation of another user based on the asset, according to embodiments of the invention.

FIG. 7 is a flowchart illustrating a method for receiving and decrypting an asset to provide a view of a 3D representation of another user based on the asset, in accordance with some implementations.

FIG. 8 is a block diagram of an electronic device, in accordance with some implementations.

FIG. 9 is a block diagram of a head-mounted device (HMD), in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

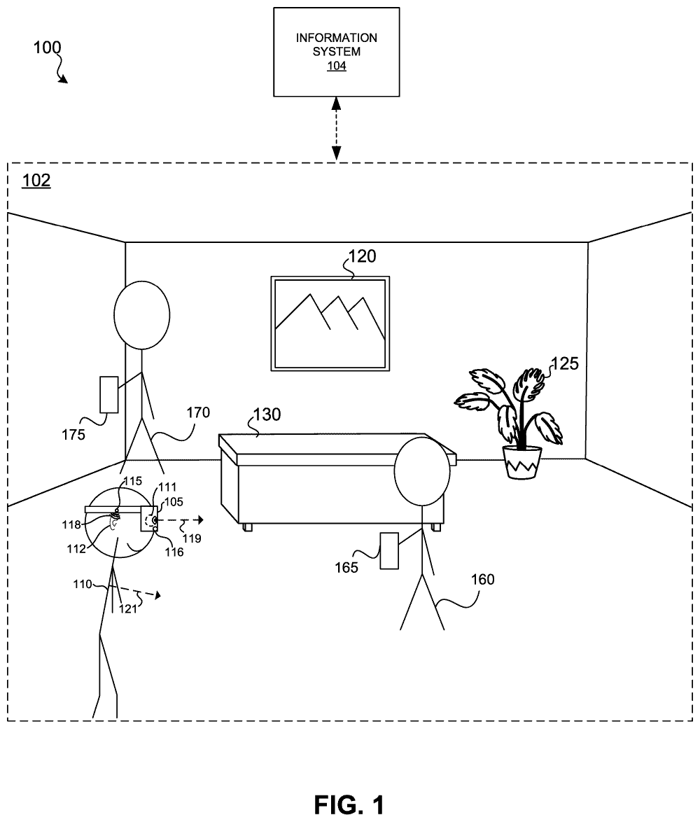

FIG. 1 illustrates an example environment 100 of exemplary electronic devices 105, 165, and 175 operating in a physical environment 102. Additionally, example environment 100 includes an information system 104 in communication with one or more of the electronic devices 105, 165, and 175. In some implementations, electronic devices 105, 165, and 175 may be able to share information with one another or an intermediary device such as the information system 104. In some implementations, the information system 104 may orchestrate the sharing, downloading, encryption/decryption, and other various processes associated with an asset, such as data associated with user representations (e.g., avatars) between two or more devices, and is further discussed herein.

Additionally, physical environment 102 includes user 110 wearing device 105, user 160 holding device 165, and user 170 holding device 175. In some implementations, the devices are configured to present views of an extended reality (XR) environment, which may be based on the physical environment 102, and/or include added content such as virtual elements providing text narrations.

In the example of FIG. 1, the physical environment 102 is a room that includes physical objects such as wall hanging 120, plant 125, and desk 130. Each electronic device 105, 165, and 175 may include one or more cameras, microphones, depth sensors, motion sensors, or other sensors that can be used to capture information about and evaluate the physical environment 102 and the objects within it, as well as information about each user 110, 160, and 170 of the electronic devices 105, 165, and 175, respectively. The information about the physical environment 102 and/or each user 110, 160, and 170 may be used to provide visual and audio content during a recording of a shared event or experience. For example, a shared experience/event session may provide views of a 3D environment that are generated based on camera images and/or depth camera images from one or more electronic devices of the physical environment 102 based on camera images and/or depth camera images captured of the environment. One or more the electronic devices may provide views of a 3D environment that includes representations of the users 110, 160, and 170.

In the example of FIG. 1, the first device 105 includes one or more sensors 116 that capture light-intensity images, depth sensor images, audio data or other information about the user 110 and the physical environment 100. For example, the one or more sensors 116 may capture images of the user's forehead, eyebrows, eyes, eye lids, cheeks, nose, lips, chin, face, head, hands, wrists, arms, shoulders, torso, legs, or other body portion. Sensor data about a user's eye 111, as one example, may be indicative of various user characteristics, e.g., the user's gaze direction 119 lover time, user saccadic behavior over time, user eye dilation behavior over time, etc. The one or more sensors 116 may capture audio information including the user's speech and other user-made sounds as well as sounds within the physical environment 102.

One or more sensors, such as one or more sensors 115 on device 105, may identify user information based on proximity or contact with a portion of the user 110. As example, the one or more sensors 115 may capture sensor data that may provide biological information relating to a user's cardiovascular state (e.g., pulse), body temperature, breathing rate, etc.

The one or more sensors 116 or the one or more sensors 115 may capture data from which a user orientation 121 within the physical environment can be determined. In this example, the user orientation 121 corresponds to a direction that a torso of the user 110 is facing.

Some implementations disclosed herein determine a user understanding based on sensor data obtained by a user worn device, such as first device 105. Such a user understanding may be indicative of a user state that is associated with providing user assistance. In some example, a user's appearance or behavior or an understanding of the environment may be used to recognize a need or desire for assistance so that such assistance can be made available to the user. For example, based on determining such a user state, augmentations may be provided to assist the user by enhancing or supplementing the user's abilities, e.g., providing guidance or other information about an environment to disabled/impaired person.

Content may be visible, e.g., displayed on a display of device 105, or audible, e.g., produced as audio 118 by a speaker of device 105. In the case of audio content, the audio 118 may be produced in a manner such that only user 110 is likely to hear the audio 118, e.g., via a speaker proximate the ear 112 of the user or at a volume below a threshold such that nearby persons (e.g., users 160, 170, etc.) are unlikely to hear. In some implementations, the audio mode (e.g., volume), is determined based on determining whether other persons are within a threshold distance or based on how close other persons are with respect to the user 110.

In some implementations, the content provided by the device 105 and sensor features of device 105 may be provided using components, sensors, or software modules that are sufficiently small in size and efficient with respect to power consumption and usage to fit and otherwise be used in lightweight, battery-powered, wearable products such as wireless ear buds or other ear-mounted devices or head mounted devices (HMDs) such as smart/augmented reality (AR) glasses. Features can be facilitated using a combination of multiple devices. For example, a smart phone (connected wirelessly and interoperating with wearable device(s)) may provide computational resources, connections to cloud or internet services, location services, etc.

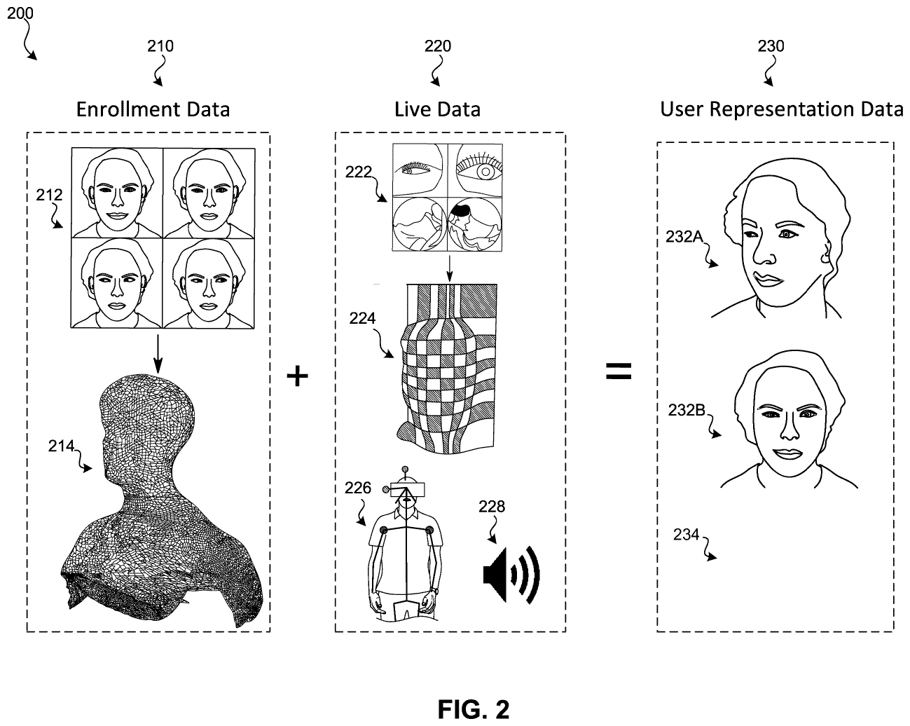

FIG. 2 illustrates an example of generating a user representation (e.g., an avatar) in accordance with some implementations. In particular, FIG. 2 illustrates an example environment 200 of a process for combining enrollment data 210 (e.g., enrollment image data 212 and a generated predetermined 3D representation 214) and live data 220 (e.g., live image data 222 and generated frame-specific 3D representations 224, body tracking data 226, and audio data 228) to generate user representation data 230 (e.g., an avatar 232 with corresponding body representation data 234).

Enrollment image data 212 illustrates images of a user (e.g., user 110 of FIG. 1) during an enrollment process. For example, the enrollment personification may be generated as the system obtains image data (e.g., RGB images) of the user's face while the user is providing different facial expressions. For example, the user may be told to “raise your eyebrows,” “smile,” “frown,” etc., in order to provide the system with a range of facial features for an enrollment process. An enrollment personification preview may be shown to the user while the user is providing the enrollment images to get a visualization of the status of the enrollment process. In this example, enrollment image data 210 displays the enrollment personification with four different user expressions, however, more or less different expressions may be utilized to acquire sufficient data for the enrollment process.

The predetermined 3D representation 214 may also be referred to herein as an “asset” or a “3D asset” associated with a user representation. The predetermined 3D representation 214 includes a plurality of vertices and polygons that may be determined at an enrollment process based on image data, such as RGB data and depth data. The predetermined 3D data may be a mesh of the user's upper body and head generated from enrollment data (e.g., one-time pixel-aligned implicit function (PIFu) data). The predetermined 3D data, such as PIFu data, may include a highly effective implicit representation that locally aligns pixels of two-dimensional (2D) images with the global context of their corresponding 3D object. In an exemplary implementation, during an enrollment process, the predetermined 3D representation 214 is generated prior to a communication session, and the predetermined 3D representation 214 (e.g., an asset) may be pre-downloaded to another device (e.g., a viewing device for the final user representation, avatar 232) before the communication session. In other words, the 3D asset data (e.g., PiFu data) may be downloaded and stored locally at the viewing device to improve delay when initiating a communication session by avoiding the on-call download of the 3D asset of the other user.

The live image data 222 of the live data 220 represents examples of acquired images of the user while using the device such as during an XR experience (e.g., live image data while using the device 10 of FIG. 1, such as an HMD). For example, the live image data 222 represents the images acquired while a user is wearing the device 105 of FIG. 1 as an HMD. For example, if the device 105 is an HMD, in one implementation, some of the one or more sensors 116 may be located inside the HMD to capture the pupillary data (e.g., eye gaze direction or 119 characteristic data), and others of the one or more sensors 116 may be located on the HMD but on the outside surface of the HMD facing towards the user's head/face to capture the facial feature data (e.g., upper facial feature characteristic data and lower facial feature characteristic data). The generated frame-specific 3D representations 224 (e.g., real-time face texture data) may be generated based on the obtained live image data 222.

In some implementations, the live data 220 may further include other data stream sources for generating user representation data 230. For example, body tracking data 226 and/or audio data 228 may be captured and provided for generating the user representation for a communication session (e.g., to view and hear an avatar of a person speaking during a call). The body tracking data 226 may be separated into different data streams based on tracking different portions of the body, such as, inter alia, the head/face as one data stream, hands as another data stream, and the upper and/or lower torso as another data stream.

User representation data 230 is an example illustration of a user during an avatar display process. For example, the avatar 232A (side facing) and avatar 232B forward facing are generated based on acquired enrollment data 210 and updated as the system obtains and analyzes the real-time image data of the live data 220 and updates different values for the planar surface (e.g., the values for the vector points of the array for the frame-specific 3D representation 224 are updated for each acquired live image data).

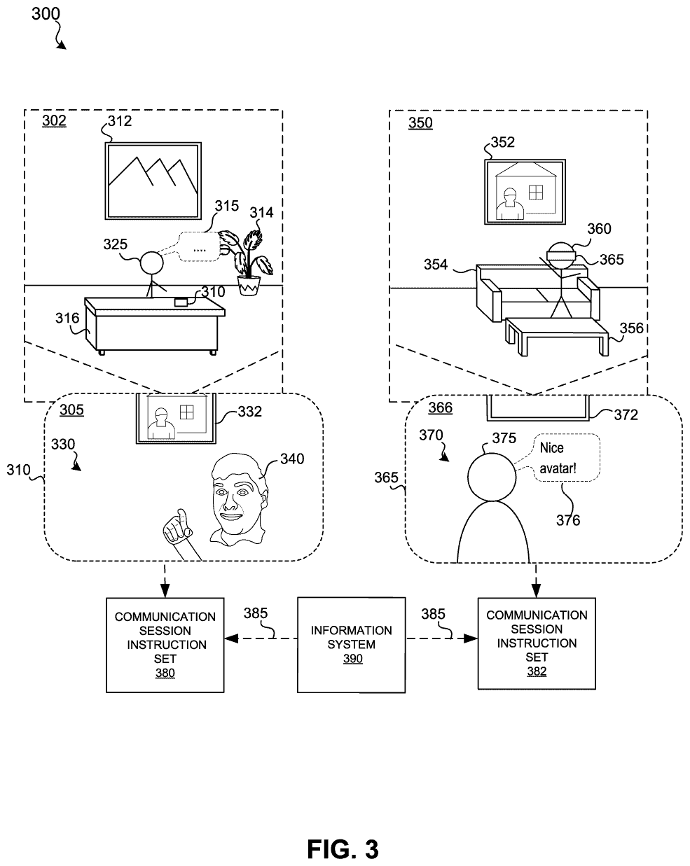

FIG. 3 illustrates exemplary electronic devices operating in different physical environments during a communication session of a first user at a first device and a second user at a second device with a view of a 3D representation of the second user for the first device in accordance with some implementations. In particular, FIG. 3 illustrates exemplary operating environment 300 of electronic devices 310, 365 operating in different physical environments 302, 350, respectively, during a communication session, e.g., while the electronic devices 310, 365 are sharing information with one another or an intermediary device such as a communication session server. In this example of FIG. 3, the physical environment 302 is a room that includes a wall hanging 312, a plant 314, and a desk 316. The electronic device 310 includes one or more cameras, microphones, depth sensors, or other sensors that can be used to capture information about and evaluate the physical environment 302 and the objects within it, as well as information about the user 325 of the electronic device 310. The information about the physical environment 302 and/or user 325 may be used to provide visual content (e.g., for user representations) and audio content (e.g., for audible voice or text transcription) during the communication session. For example, a communication session may provide views to one or more participants (e.g., users 325, 360) of a 3D environment that is generated based on camera images and/or depth camera images of the physical environment 302, a representation of user 325 based on camera images and/or depth camera images of the user 325, and/or text transcription of audio spoken by a user (e.g., a transcription bubble). As illustrated in FIG. 3, user 325 is speaking to user 360 as shown by spoken words 315.

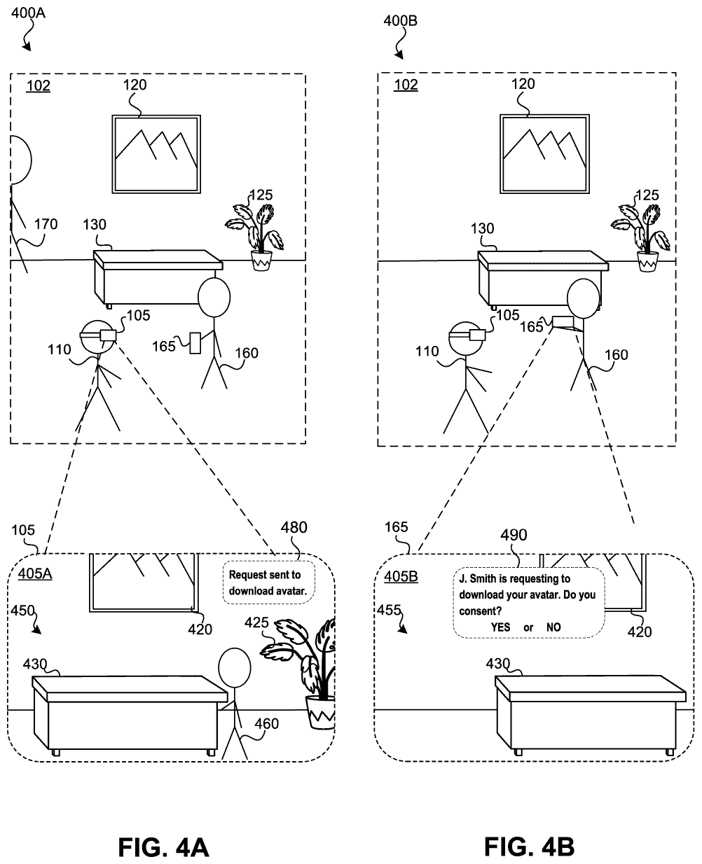

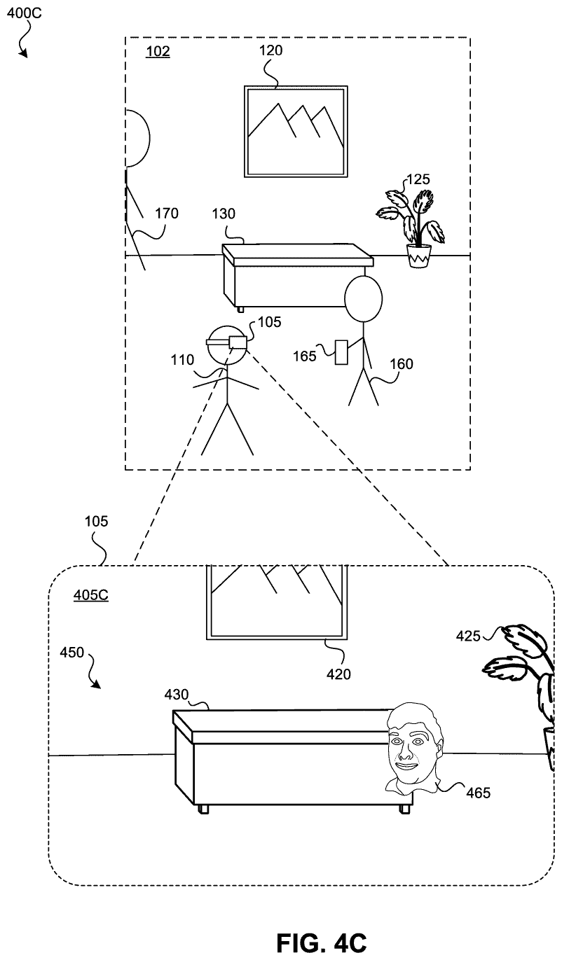

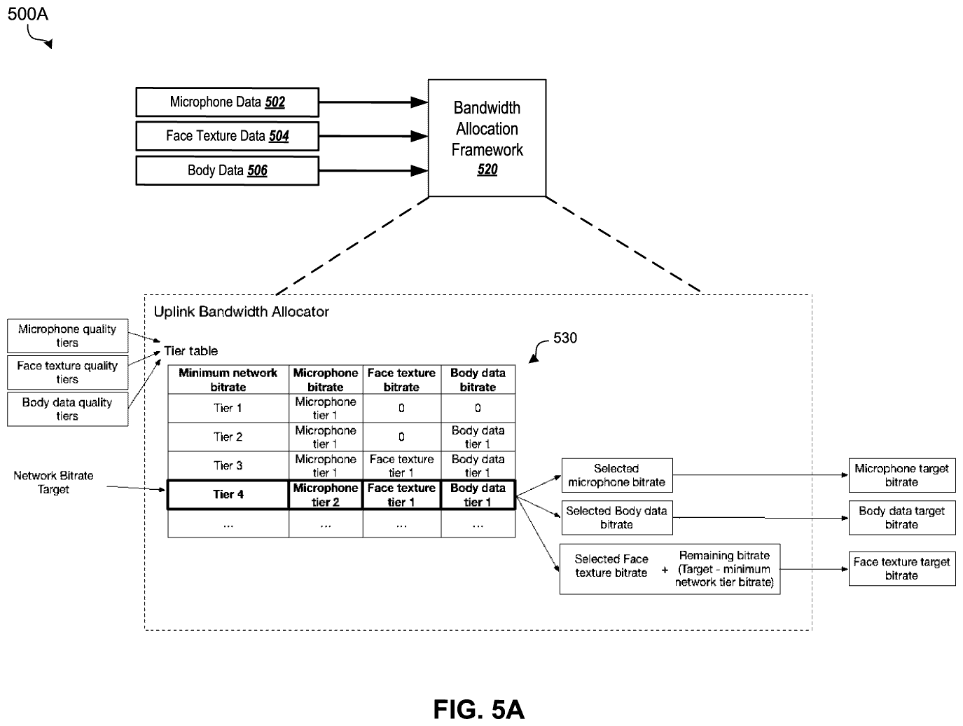

In this example, the physical environment 350 is a room that includes a wall hanging 352, a sofa 354, and a coffee table 356. The electronic device 365 includes one or more cameras, microphones, depth sensors, or other sensors that can be used to capture information about and evaluate the physical environment 350 and the objects within it, as well as information about the user 360 of the electronic device 365. The information about the physical environment 350 and/or user 360 may be used to provide visual and audio content during the communication session. For example, a communication session may provide views of a 3D environment that is generated based on camera images and/or depth camera images (from electronic device 365) of the physical environment 350 as well as a representation of user 360 based on camera images and/or depth camera images (from electronic device 365) of the user 360. For example, a 3D environment may be sent by the device 310 by a communication session instruction set 380 in communication with the device 365 by a communication session instruction set 382 (e.g., via the information system 390 via network connection 385). The information system 390 (e.g., information system 104 of FIG. 1), may orchestrate the encryption/decryption and pre-downloading of an asset (e.g., 3D asset data, such as data associated with user representations 340, 375) between two or more devices (e.g., electronic devices 310 and 365), and is further discussed herein with reference to FIG. 4. As illustrated in FIG. 3, the audio spoken by user 325 (e.g., spoken words 315) is transcribed (e.g., via communication instruction set 382) at device 365 (or via remote server), and the view 366 provides user 360 with a text transcription of audio spoken by the speaker (user 325) via the transcription bubble 376 (e.g., “Nice avatar!”).

FIG. 3 illustrates an example of a view 305 of a virtual environment (e.g., 3D environment 330) at device 310, where a representation 332 of the wall hanging 352 and a user representation 340 is provided (e.g., an avatar of user 360), provided there is a consent to view the users' representations of each user during a particular communication session. In particular, the user representation 340 of user 360 is generated based on a combined user representation technique for a more realistic avatar generated in real time. For example, predetermined 3D data (e.g., predetermined 3D representation 214, 3D asset data or simply referred to herein as an “asset”) may be obtained during an enrollment period and combined with frame-specific live data (e.g., live data 220) of the user to generate the user representation (e.g., an avatar). The predetermined 3D data may be a mesh of the user's upper body and head generated from enrollment data (e.g., one-time PIFu data). The predetermined 3D data, such as PIFu data, may include a highly effective implicit representation that locally aligns pixels of 2D images with the global context of their corresponding 3D object. The frame-specific data may represent the user's face at each of multiple points in time, e.g., live sequence of frame-specific 3D representation data such as the set of values that represent a 3D shape and appearance of a user's face at a point in time as described herein. The 3D data (e.g., two set of assets) from these two different sources (e.g., a first predetermined 3D data set and a second live frame-specific 3D data set) may be combined for each instant in time by spatially aligning the data using a 3D reference point (e.g., a point defined relative to a skeletal representation) with which both data sets are associated. However, the 3D asset data (e.g., PiFu data) may be downloaded and stored locally at the viewing device to improve delay when initiating a communication session by avoiding the on-call download of the 3D asset of the other user. The 3D representations of the user at the multiple instants in time may be generated on a viewing device that combines the data and uses the combined data to render views, for example, during a live communication (e.g., a co-presence) session.

Additionally, the electronic device 365 within physical environment 350 provides a view 366 that enables user 360 to view representation 372 of the wall hanging 312 and a representation 375 (e.g., an avatar) of at least a portion of the user 325 (e.g., from mid-torso up) within the 3D environment 370 with a transcription of the words spoken by the user 325 via the transcription bubble 376 (e.g., “Nice avatar!”). In other words, the more realistic looking avatar (e.g., user representation 340 of user 360) is generated at device 310 by generating combined 3D representations of the user 360 for the multiple instants in a period of time based on data obtained from device 365 (e.g., a predetermined 3D representation of user 360 and a respective frame-specific 3D representation of user 360). Alternatively, in some embodiments, user representation 340 of user 360 is generated at device 365 (e.g., sending device of a speaker) and sent to device 310 (e.g., viewing device to view an avatar of the speaker). In particular, each of the combined 3D representations 340 of user 360 is generated by combining a predetermined 3D representation of user 360 with a respective frame-specific 3D representation of user 360 based on an alignment (e.g., aligning a 3D reference point) according to techniques described herein.

In the example of FIG. 3, the electronic device 310 is illustrated as hand-held device and electronic device 365 is illustrated as a head-mounted device (HMD). However, either of the electronic devices 310 and 365 may be a mobile phone, a tablet, a laptop, so forth, or like electronic device 365, may be worn by a user (e.g., head-worn device (glasses), headphones, an ear mounted device, and so forth). In some implementations, functions of the devices 310 and 365 are accomplished via two or more devices, for example a mobile device and base station or a head mounted device and an ear mounted device. Various capabilities may be distributed amongst multiple device, including, but not limited to power capabilities, CPU capabilities, GPU capabilities, storage capabilities, memory capabilities, visual content display capabilities, audio content production capabilities, and the like. The multiple devices that may be used to accomplish the functions of electronic devices 310 and 365 may communicate with one another via wired or wireless communications. In some implementations, each device communicates with a separate controller or server to manage and coordinate an experience for the user (e.g., a communication session server). Such a controller or server may be located in or maybe remote relative to the physical environment 302 and/or physical environment 350.

Additionally, in the example of FIG. 3, the 3D environments 330 and 370 are XR environments that are based on a common coordinate system that can be shared with other users (e.g., a virtual room for avatars for a multi-person communication session). In other words, the common coordinate system of the 3D environments 330 and 370 are different than the coordinate system of the physical environments 302 and 350, respectively. For example, a common reference point may be used to align the coordinate systems. In some implementations, the common reference point may be a virtual object within the 3D environment that each user can visualize within their respective views. For example, a common center piece table that the user representations (e.g., the user's avatars) are positioned around within the 3D environment. Alternatively, the common reference point is not visible within each view. For example, a common coordinate system of a 3D environment may use a common reference point for positioning each respective user representation (e.g., around a table/desk). Thus, if the common reference point is visible, then each view of the device would be able to visualize the “center” of the 3D environment for perspective when viewing other user representations. The visualization of the common reference point may become more relevant with a multi-user communication session such that each user's view can add perspective to the location of each other user during the communication session.

In some implementations, the representations of each user may be realistic or unrealistic and/or may represent a current and/or prior appearance of a user. For example, a photorealistic representation of the user 325 or 360 may be generated based on a combination of live images and prior images of the user. The prior images may be used to generate portions of the representation for which live image data is not available (e.g., portions of a user's face that are not in view of a camera or sensor of the electronic device 310 or 365 or that may be obscured, for example, by a headset or otherwise). In one example, the electronic devices 310 and 365 are head mounted devices (HMD) and live image data of the user's face includes a downward facing camera that obtains images of the user's cheeks and mouth and inward facing camera images of the user's eyes, which may be combined with prior image data of the user's other portions of the user's face, head, and torso that cannot be currently observed from the sensors of the device. Prior data regarding a user's appearance may be obtained at an earlier time during the communication session, during a prior use of the electronic device, during an enrollment process used to obtain sensor data of the user's appearance from multiple perspectives and/or conditions, or otherwise.

Some implementations provide a representation of at least a portion of a user within a 3D environment other than the user's physical environment during a communication session and, based on detecting a condition, provide a representation of another object of the user's physical environment to provide context. For example, during a communication session, representations of one or more other objects of the physical environment may be displayed in the view. For example, based on determining that the user 325 is interacting with a physical object in physical environment 302, a representation (e.g., realistic or proxy) may be displayed in a view to provide context for the interaction of the user 325. For example, if the first user 325 picks up an object, such as a family picture frame, to show to another user, a view may include a realistic view of the picture frame (e.g., live video). Thus, while displaying an XR environment, the view may present a virtual object that represents the user picking up a generic object, display a virtual object that is similar to a picture frame, display previous acquired image(s) of the actual picture frame from the obtained 3D scan, or the like.

FIG. 4A illustrates exemplary electronic devices operating in the same physical environment during a communication session with a view for a first device of a first user that includes a user representation of a second user within an extended reality (XR) environment in accordance with some implementations. In particular, FIG. 4A illustrates an exemplary environment 400A of an exemplary view 405A of a physical environment 102 provided by an electronic device 105 during a communication session with user 160 using device 165. The view 405A is a 3D environment 450 that is based on the physical environment 102 and added elements, such as a user representation 460 of user 160. FIG. 4A illustrates determining whether there is consent to obtain a user representation (e.g., view an avatar with consent from user 160). For example, a consent notification 490 (for a communication session may be provided so that the second user (e.g., user 160) can be prompted that another user (e.g., user 110) is wanting to initiate a communication session (e.g., to view an avatar). In this example, during the communication session, the electronic device 105 provides a view 405A that enables user 110 to view a representation 460 of at least a portion of user 160 within the 3D environment 450 (e.g., an XR environment) from the communication session (e.g., the user 110 sees a standard or user approved generated avatar of the other user 160, may see live video of the other user 160 via pass through video, or may see a direct view of the other user 160 through a transparent or translucent display). For example, the user 110 views the representation of the other user 160 and a representation of the physical environment 102 of user 110 (e.g., an office of user 110). The view 405A includes representation 425 of plant 125, representation 420 of wall hanging 120, and representation 430 of desk 130.

In one implementation, the user 110 may verbally request from user 160 if they consent with a user representation. If the verbal request is approved, the system may use that verbal consent to proceed and allow user 110 to view the user representation from that particular user. For example, the user 110 may ask user 160 for consent, e.g., “May I use an avatar?” The user 160 may then simply reply with “Yes” to approve consent. Alternatively, the consent required may need to be more specific depending on the privacy settings. For example, the user 160 may need to specifically state the consent being requested including a particular timeframe for the different user representation, e.g., “Yes, I give my consent for you to use an avatar for our present conversation.” The device 105 and/or device 165 may record and analyze that particular audio that provides consent to recognize that a verbal consent question was posed by user 110, and that user 160 provided verbal consent. Alternatively, a notification bubble 490 may also be provided to user 160 at device 165 that includes a selection on whether or not user 160 allows consent for user 110 to view a different user representation during the current conversation between user 110 and user 160. For example, the notification bubble for allowing consent may include information such as the user requesting consent, and selectable options on a duration that the consent may or may not include. For example, a consent approver (e.g., user 160), may select to only allow a view of the user representation but not allow recording of the communication with the new user presentation. Additionally, a consent approver (e.g., user 160), may select to only allow the new user representation to be used for only a particular duration (e.g., the particular conversation with user 110, a time period such as the ten minutes, a period for an event such as the social gathering). Additionally, a consent approver (e.g., user 160), may select to allow transcription and/or recording of the audio for the particular user (e.g., user 110) indefinitely via the privacy settings (e.g., asset preference settings). In other words, user 160 may trust user 110 and always allow them to view a different user representation for private communication sessions.

FIG. 4B illustrates exemplary electronic devices operating in the same physical environment during a communication session with a view for a second device of a second user that includes a consent approval for a user representation of the second user for a view for the first user of FIG. 4A in accordance with some implementations. In particular, FIG. 4B illustrates an exemplary operating environment 400B of an exemplary view 405B of an electronic device 165 during a communication session with user 110 using device 105, where the view 405B is of a 3D environment 455 that is a representation of the physical environment 102 of the device 165. In particular, operating environment 400B illustrates a text transcription of a consent request (e.g., transcription bubble 490) for granting permission to view a user representation (e.g., an avatar) during communication session. In this example, during the communication session, the electronic device 165 provides a view 405B that enables user 160 to view a representation of the 3D environment 455 (e.g., an XR environment) from the communication session (e.g., the user 160 sees a consent approved or standard generated avatar of the other user 110, may see live video of the other user 110 via pass through video, or may see a direct view of the other user 110 through a transparent or translucent display). For example, the user 160 may view a representation of the other user 110 and a representation of the physical environment 102 of user 110 from a different perspective than user 110 viewed user 160 in FIG. 4A (e.g., the back of the room of physical environment 102).

Additionally, the view 405B includes an interactable notification bubble 490 that provides a consent request from user 110 to view a user representation (e.g., an avatar). As discussed herein, consent may be provided based on privacy settings from the user 160. For example, device 105 may be able to detect from device 165, during a communication session, that the user 160 has a privacy setting that allows user 110 to automatically use a particular user representation. Additionally, or alternatively, consent may be provided by some form of approval/engagement with the viewer as discussed herein. For example, the user 110 may verbally request from user 160 if they consent. If the verbal request is approved, the system may use that verbal consent to proceed and allow user 110 to view the new user representation.

FIG. 4C illustrates exemplary electronic devices operating in the same physical environment during a communication session with a view for the first device of the first user that includes a user representation of the second user that the second user consented to in FIG. 4B in accordance with some implementations. In particular, FIG. 4C illustrates an exemplary environment 400C of an exemplary view 405C of a physical environment 102 provided by an electronic device 105 during a communication session with user 160 using device 165. The view 405C is a 3D environment 450 that is based on the physical environment 102 and added elements, such as a combined user representation 465 of user 160 (e.g., an avatar as consented by user 160). FIG. 4C illustrates that there is consent to use and/or pre-download a user representation (e.g., view an avatar with consent from user 160). As discussed herein, combined user representation 465 may be generated based on obtaining (downloading) a first predetermined 3D data set that may be generated by the other during an enrollment period and combined with a second live frame-specific 3D data set. Thus, combined user representation 465 of the user 160 at multiple instants in time may be generated on a viewing device (e.g., device 105, an HMD) that combines the pre-downloaded data (e.g., predetermined user representation 214) with live data (e.g., generated frame-specific 3D representations 224) and uses the combined data to render views, for example, during a live communication (e.g., a co-presence) session.

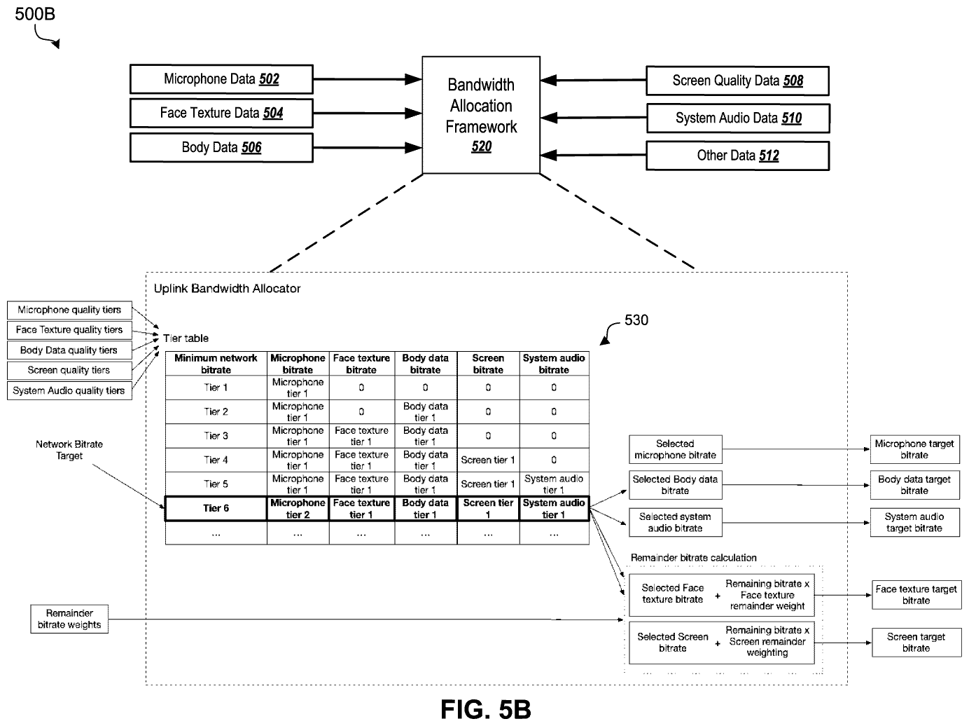

FIGS. 5A and 5B illustrate an example of modifying bandwidth allocation associated with a user representation during a communication session in accordance with some implementations. In particular, FIGS. 5A and 5B illustrate the use of an exemplary bandwidth allocation framework 520 to determine whether to modify bandwidth allocations based on different media types, such as, inter alia, microphone data 502, face texture data 504, body data 506, screen quality data 508, system audio data 510, and other data 512 that can be provided to one or more applications and/or used by system processes to provide a desirable user experience when providing views of user representations during a communication session.

The bandwidth allocation framework 520 may determine and apply different quality tiers based on the tier table 530. For example, as illustrated in FIG. 5A, microphone data 502, face texture data 504, body data 506 are all monitored to determine a network bitrate target tier (e.g., Tier 4). Based on the target tier, the bandwidth allocation framework 520 can select a microphone bitrate, a body data bitrate, and a face texture bitrate to be used during a communication session. Moreover, as illustrated in FIGS. 5A and 5B, microphone data 502, face texture data 504, body data 506, screen quality data 508, system audio data 510, and other data 512 are all monitored to determine a network bitrate target tier (e.g., Tier 6). Based on the target tier, the bandwidth allocation framework 520 can select a microphone bitrate, a body data bitrate, a face texture bitrate, a target audio bitrate, etc., to be used during a communication session.

In some implementations, the quality tiers for each media type may be inputted into the bandwidth allocation framework 520 to generate the tier table 530. The quality tiers describe the order in which media types should be increased and the bitrate amount of each increase. These increases are designed around operation points for each media type and can be tuned as needed by the bandwidth allocation framework 520. Quality tiers may be swapped dynamically during a communication session to adapt to different communication session states and may trigger a recalculation of the tier table 530. For example, if there is need for redundancy due to packet loss the face texture quality tiers may be swapped for one that has higher bitrates to accommodate the increase in bitrate requirements.

In some implementations, network bitrate target input may be used to select the highest tier in the generated tier table 530 that is still within a target. In some implementations, a remainder bitrate may be calculated by subtracting the selected tier bitrate from the network bitrate target. Remainder bitrate weights may be inputted for each media type that can benefit from additional bandwidth. During a communication session, for example, the remainder bitrate weights may be provided for face texture and screen media types. In some implementations, the weights may be used to generate a split percentage for the remainder bitrate. For example, using this percentage, a fraction of the remaining bitrate may be calculated and added to a selected tier for each media type.

In some implementations, the bandwidth allocation framework 520 is monitoring and modifying the target tier and associated bitrates before and during a communication session. For example, different quality of data connections may be experienced during a communication session, and the bandwidth allocation framework 520 can modify the experience based on those different quality of data connections in real-time.

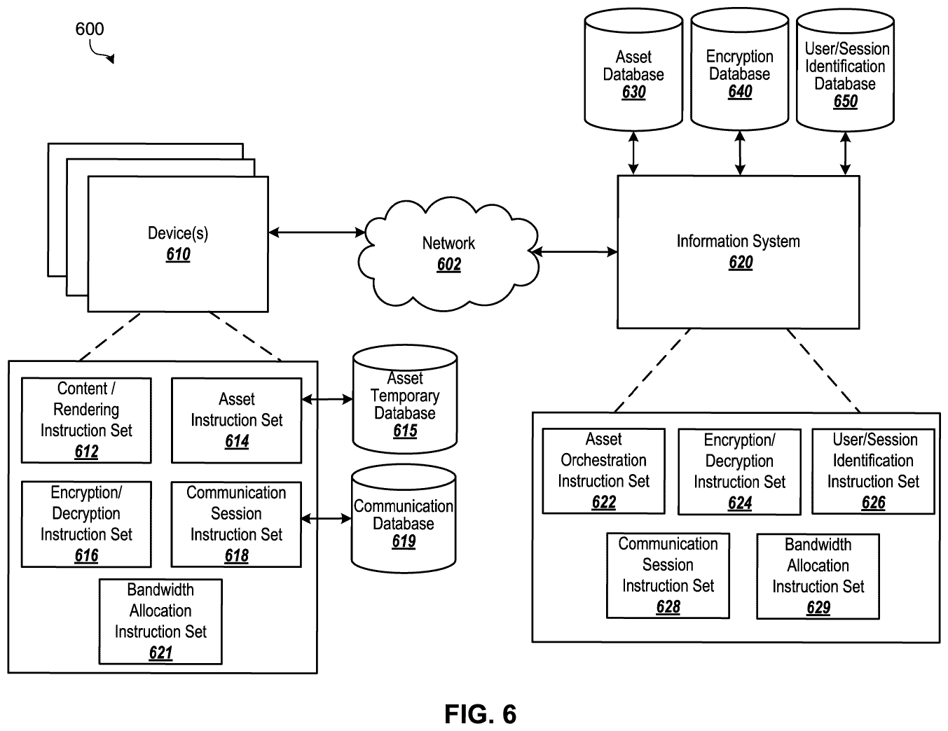

FIG. 6 illustrates an example environment 600 for implementing a process for receiving and decrypting an asset to provide a view of a 3D representation of another user, in accordance with some implementations. The example environment 600 include one or more devices 610 (e.g., electronic devices 105, 165, 175, 310, 365, etc.), and an information system 620, that communicates over a data communication network 602, e.g., a local area network (LAN), a wide area network (WAN), the Internet, a mobile network, or a combination thereof.

The electronic device 610 (e.g., an electronic device used by a user, such as user device 105 used by user 110) may be a mobile phone, a tablet, a laptop, so forth. In some implementations, electronic device 610 may be worn by a user. For example, electronic device 610 may be a watch, a head-mounted device (HMD), head-worn device (glasses), headphones, an ear mounted device, and so forth. In some implementations, functions of the device 610 are accomplished via two or more devices, for example a mobile device and base station or a head mounted device and an ear mounted device. Various capabilities may be distributed amongst multiple devices, including, but not limited to power capabilities, CPU capabilities, GPU capabilities, storage capabilities, memory capabilities, visual content display capabilities, audio content production capabilities, and the like. The multiple devices that may be used to accomplish the functions of electronic devices 610, 105, 165, 175, 310, 365, etc., may communicate with one another via wired or wireless communications over network 602. In some implementations, each device communicates with a separate controller or server to manage and coordinate an experience for the user (e.g., an information system 620 utilizing a communication session instruction set 628). Such a controller or server may be located in or may be remote relative to the physical environment of the device 610 (e.g., physical environment 102).

In an example implementation, the device 610 includes a content/rendering instruction set 612 that is configured with instructions executable by a processor to obtain sensor data (e.g., RGB data, depth data, etc.) of a current physical environment, and data associated with a user representation of another user to generate 3D representation data (e.g., a view of an XR environment) using one or more techniques. For example, the content/rendering instruction set 612 analyzes RGB images from a light intensity camera with a sparse depth map from a depth camera (e.g., time-of-flight sensor, passive or active stereo sensors such as a structured light depth camera, and the like), and other sources of physical environment information (e.g., camera positioning information such as VIO data, or a camera's SLAM system, or the like) to generate a view of 3D representation data. For example, as illustrated in example view 405A in FIG. 4A, 3D representation data may include the representation 430 of the desk 130, representation 460 of the user 160 (e.g., an avatar) and a representation 420 of the wall hanging 120.

In an example implementation, the device 610 includes an asset instruction set 614 that is configured with instructions executable by a processor to obtain asset and/or asset preference settings of a current user of device 610 or another user of another device. For example, in some implementations, the device 610 via asset instruction set 614 obtains the asset and/or asset preference settings for another user from the information system 620 via the asset orchestration instruction set 622 and/or the global asset database 630. Alternatively, in some implementations, the device 610 via asset instruction set 614 obtains the asset and/or asset preference settings for another user from the asset temporary database 615 (e.g., for locally saving assets if the other previously provided consent for the user to store the asset). In some implementations, the device 610 via asset instruction set 614 obtains the asset for the current user from the asset temporary database 615 and sends those assets to another device 610 for the other user via the asset orchestration instruction set 622 of the information system 620.

In an example implementation, the device 610 includes an encryption/decryption instruction set 616 that is configured with instructions executable by a processor to facilitate the encryption and decryption processes associated with an encrypted asset. For example, in some implementations, the device 610 via encryption/decryption instruction set 616 obtains an encryption key from the information system 620 via the encryption/decryption instruction set 624 and/or the encryption database 640. In some implementations, the device 610 via encryption/decryption instruction set 616 obtains the asset for the current user from the asset temporary database 615 and then requests an encryption key from the information system 620 via the encryption/decryption instruction set 624. In some implementations, the encryption key includes an encryption token that corresponds to decrypting the asset that is associated with the 3D representation of the second user. For example, the encryption key may correspond to an encryption token used to encrypt the asset, and when a user at a first device enters a communication session with a second device, the first device will receive an encryption key. Then if the first device is approved (e.g., via the information system 620), the first device can use the encryption key to decrypt the associated avatar asset.

In an example implementation, the device 610 includes a communication session instruction set 618 that is configured with instructions executable by a processor to facilitate a communication session between one or more other users via another device 610. For example, as illustrated in FIG. 3, a communication session may provide views of a 3D environment that is generated based on camera images and/or depth camera images (from electronic device 310) of a physical environment (e.g., physical environment 302) as well as representations of the other users (e.g., user representation 340 of user 360) based on camera images and/or depth camera images (from electronic device 365) of the user 360. For example, as illustrated in FIG. 3, a 3D environment may be sent by the device 310 by a communication session instruction set 380 in communication with the device 365 by a communication session instruction set 382 (e.g., communications facilitated by information system 390 via network 385). In some implementations, a communication database 619 may be used to locally store communication session information for a device 610 (e.g., store call history information, asset preference settings, scheduled event information, and the like), and/or a user/session identification database 650 via the information system 620 may be used to anonymously store communication session information for one or more devices 610 (e.g., store call history information, asset preference settings, scheduled event information, and the like).

In an example implementation, the device 610 includes a bandwidth allocation instruction set 621 that is configured with instructions executable by a processor to facilitate the bandwidth allocation of multiple data streams associated with an encrypted asset during a communication session. For example, in some implementations, the device 610 via the bandwidth allocation instruction set 621 can monitor and modify different data streams when generating a view of a user representation, such as face texture data, body data, microphone data, audio data, screen quality data, or a combination thereof.

The information system 620 (e.g., a server within the information system 104) is an external server that is configured to facilitate an asset downloading/sharing system between two or more devices 610. In some implementations, the information system 620 determines that a first device 610 of a first user may pre-download an asset (e.g., a user presentation) associated with a second user from a second device based on one or more criterion (e.g., call history, a scheduled event, a trigger event, via user consent, and the like). For example, the information system 620 can access an asset and/or asset preference setting associated with user 160 at device 165 from the global asset database 630 or facilitate the sharing of an asset from a first device to a second device.

In an example implementation, the information system 620 includes an asset orchestration instruction set 622 that is configured with instructions executable by a processor to facilitate the exchange of an asset and/or asset preference settings between two or more devices 610 (e.g., between device 105 and device 165 as discussed herein with reference to FIGS. 4A-4C). For example, the information system 620 may access an asset (e.g., an avatar for user representation 340 of user 360) via the asset orchestration instruction set 622 and determines whether or not to allow downloading of the asset prior to a communication session.

In an example implementation, the information system 620 includes an encryption/decryption instruction set 624 that is configured with instructions executable by a processor to facilitate the encryption and decryption processes associated with an encrypted asset with a plurality of devices 610 (e.g., user devices 105, 165, 175, 310, 365, etc.). For example, in some implementations, the information system 620 via the encryption/decryption instruction set 624 obtains an encryption key from the encryption database 640 and sends the encryption key to a device 610 via encryption/decryption instruction set 616. In some implementations, the encryption key includes an encryption token that corresponds to decrypting the asset that is associated with the 3D representation of the second user. For example, the encryption key may correspond to an encryption token used to encrypt the asset, and when a user at a first device enters a communication session with a second device, the first device will receive an encryption key. Then if the first device is approved (e.g., via the information system 620), the first device can use the encryption key to decrypt the associated avatar asset.

In an example implementation, the information system 620 further includes a user/session identification instruction set 626 that is configured with instructions executable by a processor to facilitate the user and communication session identifications between device(s) 610, as well as store any identification information in the user/session identification database 650. For example, determining whether or not a device 610 is allowed to pre-download an avatar may be based on identifying an enrollment session has occurred at another device based on a contact list that may be anonymously shared and stored in the user/session identification database 650 and accessed anonymously by the ser/session identification instruction set 626. In an example implementation, the information system 620 further includes a communication session instruction set 628 that is configured with instructions executable by a processor to facilitate a communication session between one or more other users via two or more devices 610. In an example implementation, the information system 620 further includes a bandwidth allocation instruction set 629 that is configured with instructions executable by a processor to facilitate the bandwidth allocation of multiple data streams associated with an encrypted asset during a communication session via two or more devices 610. For example, the information system 620 may facilitate the sharing of bitrate characteristics associated with a first user device to a second user device during a communication session.

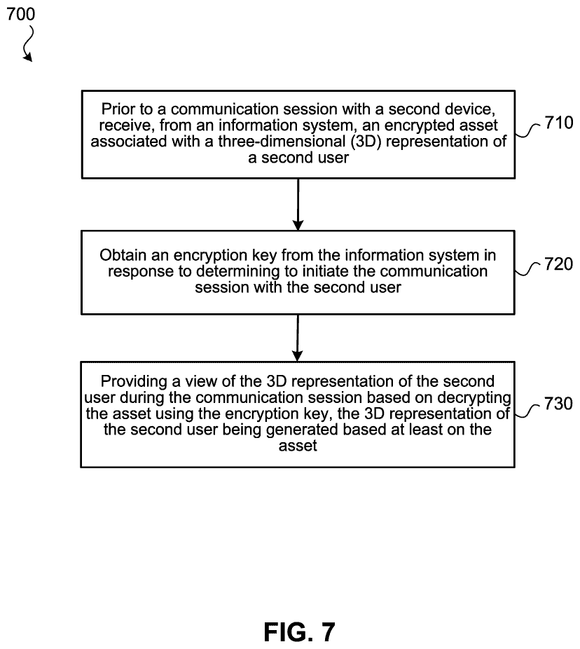

FIG. 7 is a flowchart illustrating a method 700 for receiving and decrypting an asset to provide a view of a 3D representation of another user based on the asset, in accordance with some implementations. In some implementations, a device, such as electronic device 105, or electronic devices 165, 175, 310, 365, and the like, or a combination of any/each, performs method 700. In some implementations, method 700 is performed on a mobile device, desktop, laptop, HMD, ear-mounted device or server device (e.g., information system 520), or a combination thereof. The method 700 is performed by processing logic, including hardware, firmware, software, or a combination thereof. In some implementations, the method 700 is performed on a processor executing code stored in a non-transitory computer-readable medium (e.g., a memory).

At block 710, the method 700, prior to a communication session with a second device, receives, from an information system, an encrypted asset associated with a three-dimensional (3D) representation of a second user. For example, a 3D asset may be pre-downloaded prior to a communication session with another device. The information system (e.g., information system 620) may send push notifications (e.g., based on an enrollment from the other user, contact list, call history, a calendar planned event, etc.) to devices that are likely to be in a communication session with a user and those devices can pre-download the avatar asset (e.g., generated predetermined 3D representation 214). The pre-download may be initiated based on a trigger event, such as server determining to push and/or the first device requesting the 3D asset, determining current asset is out of date or removed, may be based on a contact list or call history list, a scheduled calendar event, and the like.

At block 720, the method 700 obtains an encryption key from the information system in response to determining to initiate the communication session with the second user. For example, the encryption key may correspond to an encryption token used to encrypt the asset (e.g., used to access the downloaded predetermined 3D representation 214). Thus, when a first user enters a communication session with the second user, the first device of the first user will receive an encryption key (if approved) that can be used to decrypt the associated avatar asset. In some implementations, avatar asset will periodically be deleted from user devices (e.g., after a certain period of time such as after 30 days).

At block 730, the method 700 provides a view of the 3D representation of the second user during the communication session based on decrypting the asset using the encryption key, the 3D representation of the second user being generated based at least on the asset. The view may be an XR environment. For example, as illustrated in FIG. 3, the user representation 340 of user 360 is generated based on a combined user representation of a pre-downloaded predetermined 3D representation (e.g., asset data, such as PiFu data) with real-time data acquired during the communication session.

In exemplary implementations, there may be one or more different factors for initiating pre-downloading of an asset/avatar, e.g., a contact list, previous communication sessions, an enrollment trigger, push notifications, current system traffic/load, calendar event, and the like. In some implementations, receiving the asset is in response to identifying a trigger event associated with the first device, the second device, the information system, or a combination thereof. In some implementations, the user event is based on at least one of an enrollment of the asset at the second device or the information system, a contact list associated with the first device or the second device, a push notification to the first device from the information system, a scheduled event associated with the first device or the second device (e.g., a calendar event), a previous communication session between the first device and the second device, system or network traffic associated with the communication session, and a request from the first device to obtain the asset. For example, a server may send push notifications (based on an enrollment from the second user, a contact list, call history, etc.) to devices that are likely to be in a communication session with a user and those devices can pre-download the avatar asset. The pre-downloading may be based on a trigger event, such as server determining to push and/or the first device requesting the 3D asset.

In some implementations, receiving the asset is in response to determining that an expiration date associated with the asset has expired or the asset has been removed from the first device. For example, determining that the current asset is out of date or has already been removed from the first device, and thus, the first device needs to obtain (download) the asset again. In some implementations, after receiving the asset, the asset is stored at the first device for a threshold amount of time. For example, 3D assets may be stored temporarily at the first device, and after a threshold amount of time, the 3D assets are deleted (e.g., 30 days, 3 weeks, etc.). In some implementations, the 3D assets may be downloaded prior to an event, and then immediately removed after that event, or at least may only be able to decrypt the 3D asset one time (e.g., a one-time scheduled meeting).

In some implementations, the encryption key includes an encryption token that corresponds to decrypting the asset that is associated with the 3D representation of the second user. For example, the encryption key may correspond to an encryption token used to encrypt the asset, and when a user at a first device enters a communication session with a second device, the first device will receive an encryption key. Then if the first device is approved (e.g., via the information system), the first device can use the encryption key to decrypt the associated avatar asset.

In some implementations, the asset is a first asset, wherein when the first device receives the first asset, the first device receives a second asset associated with the 3D representation of a second user, and wherein the first asset is different than the second asset. For example, there may be more than one 3D asset to download for another user based on context (e.g., a work avatar versus a personal avatar). In some implementations, providing the view of the 3D representation of the second user is based on determining whether to generate the 3D representation of the second user using the first asset or using the second asset. For example, based on a contact list, use a different avatar. Additionally, or alternatively, in some implementations, determining whether to generate the 3D representation of the second user using the first asset or using the second asset may be based on determining a context of the environment, such as using a professional avatar based on determining the environment is a business-like setting.

In various implementations, bandwidth allocation may be implemented for persona-to-persona screen sharing (e.g., sharing avatars or views of 3D environments presented by a device during a communication session). In some implementations, the method 700 may further include updating the view of the 3D representation of the second user based on modifying bandwidth allocation between two or more data streams associated with the communication session. In some implementations, the two or more data streams associated with the communication session are based on face texture data, body data, microphone data, audio data screen quality data, or a combination thereof. For example, as illustrated in FIGS. 5A and 5B, quality tiers for each data stream may be determined as illustrated by the tier table 530. Each data stream may be monitored and modified by the bandwidth allocation framework based on the tier table 530.

In some implementations, the view of the 3D representation of the second user is updated during the communication session based on receiving first set of data associated with a first portion of the second user and receiving second set of data associated with a second portion of the second user, wherein the first portion is different than the second portion. For example, data associated with the head/face may be separate than data associated with the hands and/or body. In some implementations, the method 700 further includes, determining whether there is motion associated with the first portion or the second portion of the second user during the communication session, and in response to detecting motion with the first portion of the second user, modifying bandwidth allocation between the first set of data and the second set of data. For example, modify the bandwidth allocation based on detecting that the head of the second user is moving, but not the hands/body (e.g., sitting down but turning his or her head while communication with the first user during the communication session).

In some implementations, for the communication session, the first user may be in the same physical environment (3D environment) as the second user. Alternatively, the 3D environment may be an XR environment, and the first user is participating (speaking) in the same XR environment as the second user, even though the first user and second user may be in different physical environments. For example, as illustrated in FIG. 3, user 325 is located at their office in physical environment 302, and user 360 is located at their living room in physical environment 350, but they are communicating via associated avatars during a virtual communication session in a 3D environment 330, 370.

In some implementations, the information system is a server external to the first device (e.g., information system 620). Alternatively, in some implementations, the information system is located at the first device. For example, a device (e.g., device 105) may stores known assets of previously known users in a locally stored database (e.g., asset temporary database 615).

In some implementations, the method 700 receives an asset and/or an asset preference setting associated with the second user for depicting or augmenting the second user in the 3D environment from the information system. In some implementations, the first device (e.g., the first user's own display preferences) may determine to use or not use the second user's preferences in general/public use cases. In some implementations, in which the first user has agreed, the asset associated with the second user may automatically be implemented.

In some implementations, the method 700 further includes determining whether the second user consents to sending the assets to the first user. In an exemplary embodiment, the method 700 receives a determination whether the second user provides user consent to the receiving the asset and/or asset preference setting associated with the second user at the first device from the information system. In some implementations, the user consent is a particular type of the asset and/or asset preference setting. For example, as illustrated in FIGS. 4A-4C, the first device requests to download a user representation of the second user, who is then notified of this request and consents.

In some implementations, the information system determines that the second user provides user consent to the receiving the asset and/or asset preference setting associated with the second user at the first device based on receiving, at the first device via the information system, an affirmative response from the second user (or from a device associated with the second user) to a consent request. For example, as illustrated in FIG. 4B, the user 160 is provided a notification bubble 490 that the second user 160 needs to affirmatively select whether or not to allow consent (e.g., via an input device such as a mouse, via selecting an interactable element on the display of the device 165, via an audio cue such as saying “yes”, or the like).

In some implementations, the information system determines that the second user provides user consent to the receiving the asset and/or asset preference setting associated with the second user at the first device based on determining that a privacy setting associated with the second user (or from a device associated with the second user) allows providing the asset and/or asset preference setting of the second user to the first user. For example, the information system 520 can access an asset and/or asset preference setting associated with user 160 at device 165 from the global asset database 530 (e.g., via an anonymous system).

In some implementations, the information system determines that the second user provides user consent to the receiving the asset and/or asset preference setting associated with the second user at the first device based on determining that the first user operating the first device was previously identified by the second user to have consent to downloading the asset. For example, device 105 may have previously connected with device 165 and the user 160 provided consent and/or allowed user 110 to have consent in future communication sessions, and thus device 105 can store the asset and/or asset preference setting locally (e.g., device 610 can obtain asset and/or asset preference settings for device 610 or other devices, such as device 165, from the asset temporary database 615 via the asset instruction set 614).

In some implementations, the presenting the view of the 3D environment that includes a depiction or augmentation of a representation of the second user is based on the asset and/or asset preference setting associated with the second user. For example, as illustrated in FIG. 4C, the avatar (user representation 465) is presented as the user representation for user 160. In some implementations, presenting the view of the 3D environment that includes the depiction or the augmentation of the representation of the second user is based on user consent provided by the second user based on the asset and/or asset preference setting associated with the second user.

In some implementations, the information system is configured to identify the first device based on at least one of position data, identify an account associated with the first device, and/or identify the assets associated with the account. For example, the information system 620 can access the assets associated with user 160 (e.g., an avatar) from a global asset database 630.

In some implementations, the method 700 further includes determining whether to use the asset associated with the second user based on a determined context of the 3D environment. For example, the asset and/or asset preference settings are determined based on a scene understanding of the 3D environment (e.g., a private conversation or general/public use). For example, positioning/characteristics of the user representations may be different based on aspects from a scene understanding of the 3D environment and the associated asset and/or asset preference settings (e.g., as stored in a global asset database 630). For example, if at a concert, the user representation may be more noticeable, where if the users are watching a movie, a more subtle user representation may be used. For example, a scene analysis of an experience determines a scene understanding of the visual and/or auditory attributes associated with content being presented to the user (e.g., what is being presented within the 3D environment) and/or attributes associated with the environment of the user (e.g., where is the user, what is the user doing, what objects are nearby). These attributes of both the presented content and environment of the user can improve the determination of the type of physical and/or XR environment the user's (e.g., the speaker and the listener) are in.

In some implementations, the method 700 provides positional data during a communication session between a first device and a second device. In some implementations, a view of the 3D environment including a representation of a user of the first device positioned based on the position data is presented to a user of the second device during the communication session. In some implementations, the representation of the first user may be based on asset data obtained during the communication session (e.g., a user preferred avatar). Additionally, a privacy option may enable the first user to limit or otherwise select portions of the 3D environment to be shared if the communication session is displaying a representation of the physical environment of one of the users. In some implementations, the user may be provided with an indication of what is being shared to the second user, such as a preview of the user representation (e.g., an avatar) being shared with the second user before the second user is allowed to view the user representation.

In some implementations, a view of the communication session is presented in an XR experience. In some implementations, each electronic device (e.g., electronic devices 105, 165, 175, 310, 365, and the like) is an HMD. For example, if each user in the communication session (e.g., user 110 and user 160) is wearing an HMD, then providing a view of the representation of each user (e.g., an avatar) while engaging in a video/XR conversation would be more suitable than displaying a view of the user because the HMD may be cumbersome and may cover the user's face.

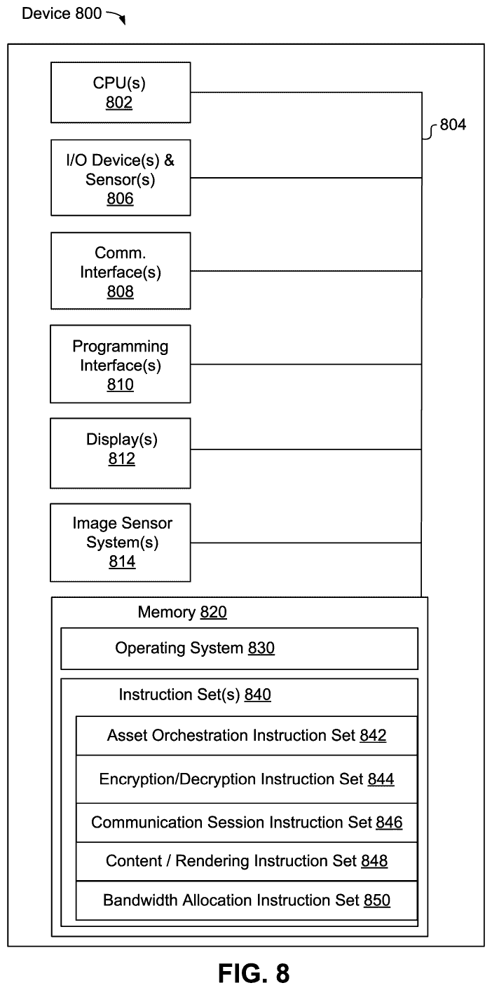

FIG. 8 is a block diagram of electronic device 800. Device 800 illustrates an exemplary device configuration for an electronic device, such as device 105, 165, 175, 310, 365, 610, etc. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 800 includes one or more processing units 802 (e.g., microprocessors, ASICs, FPGAs, GPUs, CPUs, processing cores, and/or the like), one or more input/output (I/O) devices and sensors 806, one or more communication interfaces 808 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 810, one or more display(s) 812 or other output devices, one or more interior and/or exterior facing image sensor systems 814, a memory 820, and one or more communication buses 804 for interconnecting these and various other components.

In some implementations, the one or more communication buses 804 include circuitry that interconnects and controls communications between system components. In some implementations, the one or more I/O devices and sensors 806 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 812 include one or more displays configured to present a view of a 3D environment to the user. In some implementations, the one or more device(s) 812 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 800 includes a single display. In another example, the device 800 includes a display for each eye of the user.

In some implementations, the one or more output device(s) 812 include one or more audio producing devices. In some implementations, the one or more output device(s) 812 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 812 may additionally or alternatively be configured to generate haptics.

In some implementations, the one or more image sensor systems 814 are configured to obtain image data that corresponds to at least a portion of a physical environment. For example, the one or more image sensor systems 814 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 814 further include illumination sources that emit light, such as a flash. In various implementations, the one or more image sensor systems 814 further include an on-camera image signal processor (ISP) configured to execute a plurality of processing operations on the image data.

The memory 820 includes high-speed random-access memory, such as DRAM, SRAM, DDR RAM, or other random-access solid-state memory devices. In some implementations, the memory 820 includes non-volatile memory, such as one or more magnetic disk storage devices, optical disk storage devices, flash memory devices, or other non-volatile solid-state storage devices. The memory 820 optionally includes one or more storage devices remotely located from the one or more processing units 802. The memory 820 includes a non-transitory computer readable storage medium.

In some implementations, the memory 820 or the non-transitory computer readable storage medium of the memory 820 stores an optional operating system 830 and one or more instruction set(s) 840. The operating system 830 includes procedures for handling various basic system services and for performing hardware dependent tasks. In some implementations, the instruction set(s) 840 include executable software defined by binary information stored in the form of an electrical charge. In some implementations, the instruction set(s) 840 are software that is executable by the one or more processing units 802 to carry out one or more of the techniques described herein.

The instruction set(s) 840 includes an asset orchestration instruction set 842, an encryption/decryption instruction set 844, a communication session instruction set 846, a content/rendering instruction set 848, and a bandwidth allocation instruction set 850. The asset orchestration instruction set 842 may be configured to, upon execution, may orchestrate the sharing of assets between devices as described herein. The encryption/decryption instruction set 844 may be configured to, upon execution, implement the encryption and/or decryption processes as described herein. The communication session instruction set 846 may be configured to, upon execution, implement the communication sessions between two or more devices as described herein. The content/rendering instruction set 848 may be configured to, upon execution, determine content and/or rendering instructions for a device as described herein. The bandwidth allocation instruction set 850 may be configured to, upon execution, determine and modify bandwidth of data streams associated with a communication session as described herein. The instruction set(s) 840 may be embodied as a single software executable or multiple software executables.

Although the instruction set(s) 840 are shown as residing on a single device, it should be understood that in other implementations, any combination of the elements may be located in separate computing devices. Moreover, the FIG. is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

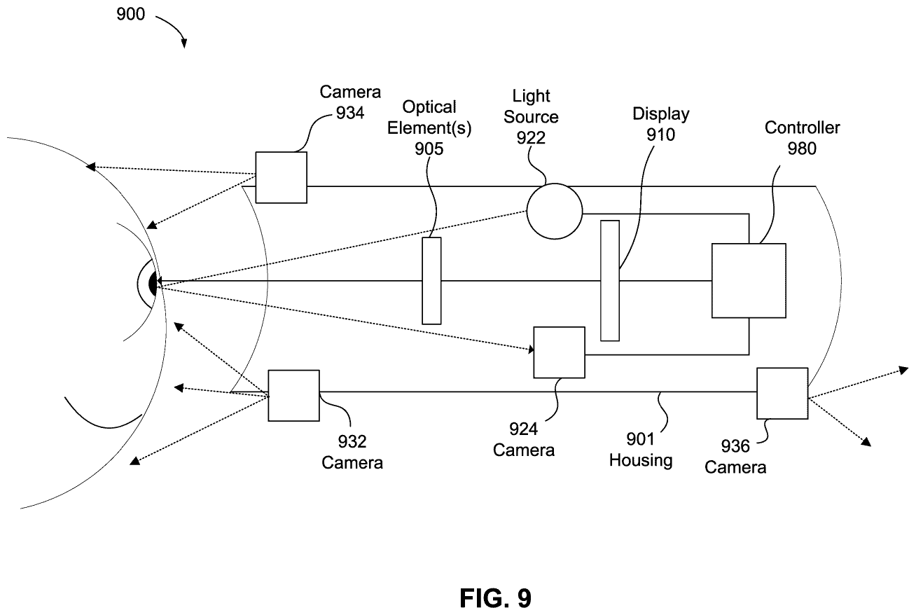

FIG. 9 illustrates a block diagram of an exemplary head-mounted device 900 in accordance with some implementations. The head-mounted device 900 includes a housing 901 (or enclosure) that houses various components of the head-mounted device 900. The housing 901 includes (or is coupled to) an eye pad (not shown) disposed at a proximal (to the user 110) end of the housing 901. In various implementations, the eye pad is a plastic or rubber piece that comfortably and snugly keeps the head-mounted device 900 in the proper position on the face of the user 110 (e.g., surrounding the eye of the user 110).

The housing 901 houses a display 910 that displays an image, emitting light towards or onto the eye of a user 110. In various implementations, the display 910 emits the light through an eyepiece having one or more optical elements 905 that refracts the light emitted by the display 910, making the display appear to the user 110 to be at a virtual distance farther than the actual distance from the eye to the display 910. For example, optical element(s) 905 may include one or more lenses, a waveguide, other diffraction optical elements (DOE), and the like. For the user 110 to be able to focus on the display 910, in various implementations, the virtual distance is at least greater than a minimum focal distance of the eye (e.g., 7 cm). Further, in order to provide a better user experience, in various implementations, the virtual distance is greater than 1 meter.

The housing 901 also houses a tracking system including one or more light sources 922, camera 924, camera 932, camera 934, camera 936, and a controller 980. The one or more light sources 922 emit light onto the eye of the user 110 that reflects as a light pattern (e.g., a circle of glints) that may be detected by the camera 924. Based on the light pattern, the controller 980 may determine an eye tracking characteristic of the user 110. For example, the controller 980 may determine a gaze direction and/or a blinking state (eyes open or eyes closed) of the user 110. As another example, the controller 980 may determine a pupil center, a pupil size, or a point of regard. Thus, in various implementations, the light is emitted by the one or more light sources 922, reflects off the eye of the user 110, and is detected by the camera 924. In various implementations, the light from the eye of the user 110 is reflected off a hot mirror or passed through an eyepiece before reaching the camera 924.

The display 910 emits light in a first wavelength range and the one or more light sources 922 emit light in a second wavelength range. Similarly, the camera 924 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 110 selects an option on the display 910 by looking at it), provide foveated rendering (e.g., present a higher resolution in an area of the display 910 the user 110 is looking at and a lower resolution elsewhere on the display 910), or correct distortions (e.g., for images to be provided on the display 910).

In various implementations, the one or more light sources 922 emit light towards the eye of the user 110 which reflects in the form of a plurality of glints.

In various implementations, the camera 924 is a frame/shutter-based camera that, at a particular point in time or multiple points in time at a frame rate, generates an image of the eye of the user 110. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 924 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 932, camera 934, and camera 936 are frame/shutter-based cameras that, at a particular point in time or multiple points in time at a frame rate, may generate an image of the face of the user 110 or capture an external physical environment. For example, camera 932 captures images of the user's face below the eyes, camera 934 captures images of the user's face above the eyes, and camera 936 captures the external environment of the user (e.g., environment 100 of FIG. 1). The images captured by camera 932, camera 934, and camera 936 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws.

It is to be understood that the implementations shown and described herein are only illustrative of the principles of the present invention and that various modification may be implemented by those skilled in the art without departing from the scope and spirit of the invention.

What is claimed is:

1. A method comprising:
at a first device operated by a first user, the first device having a processor:
prior to a communication session with a second device, receiving, from an information system, an asset associated with a three-dimensional (3D) representation of a second user, wherein the asset is encrypted;
in response to determining to initiate the communication session with the second user, obtaining an encryption key from the information system; and
providing a view of the 3D representation of the second user during the communication session based on decrypting the asset using the encryption key, wherein the 3D representation of the second user is generated based at least on the asset.

2. The method of claim 1, wherein receiving the asset is in response to identifying a trigger event associated with the first device, the second device, the information system, or a combination thereof.

3. The method of claim 2, wherein the trigger event is based on at least one of:
an enrollment of the asset at the second device or the information system;
a contact list associated with the first device or the second device;
a push notification to the first device from the information system;
a scheduled event associated with the first device or the second device;
a previous communication session between the first device and the second device;
system or network traffic associated with the communication session; and
a request from the first device to obtain the asset.

4. The method of claim 1, receiving the asset is in response to determining that an expiration date associated with the asset has expired or the asset has been removed from the first device.

5. The method of claim 1, wherein after receiving the asset, the asset is stored at the first device for a threshold amount of time.

6. The method of claim 1, wherein the encryption key comprises an encryption token that corresponds to decrypting the asset that is associated with the 3D representation of the second user.

7. The method of claim 1, wherein the asset is a first asset, wherein when the first device receives the first asset, the first device receives a second asset associated with the 3D representation of a second user, and wherein the first asset is different than the second asset.

8. The method of claim 7, wherein providing the view of the 3D representation of the second user is based on determining whether to generate the 3D representation of the second user using the first asset or using the second asset.

9. The method of claim 1, further comprising:
updating the view of the 3D representation of the second user based on modifying bandwidth allocation between two or more data streams associated with the communication session.

10. The method of claim 9, wherein the two or more data streams associated with the communication session are based on:
face texture data;
body data;
microphone data;
audio data;
screen quality data; or
a combination thereof.

11. The method of claim 1, wherein the view of the 3D representation of the second user is updated during the communication session based on receiving first set of data associated with a first portion of the second user and receiving second set of data associated with a second portion of the second user, wherein the first portion is different than the second portion.

12. The method of claim 11, further comprising:
determining whether there is motion associated with the first portion or the second portion of the second user during the communication session; and
in response to detecting motion with the first portion of the second user, modifying bandwidth allocation between the first set of data and the second set of data.

13. The method of claim 1, further comprising:
receiving, from the information system, a determination whether the second user provides user consent to the receiving the asset associated with the second user at the first device.

14. The method of claim 13, wherein the user consent is a particular type of the asset or asset preference setting.

15. The method of claim 13, wherein the information system determines that the second user provides user consent to receiving the asset associated with the second user at the first device based on receiving, at the first device via the information system, an affirmative response from the second user to a consent request.

16. The method of claim 1, wherein the information system determines that the second user provides user consent to the receiving the asset associated with the second user at the first device based on determining that a privacy setting associated with the second user allows providing the asset of the second user to the first user.

17. The method of claim 1, wherein the information system determines that the second user provides user consent to receiving the asset associated with the second user at the first device based on determining that the first user operating the first device was previously identified by the second user to have consent to the asset and/or asset preference setting.

18. The method of claim 1, wherein the information system is configured to identify the first device based on at least one of position data, an account associated with the first device, and assets associated with the account.

19. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
prior to a communication session with a second device, receiving, from an information system, an asset associated with a three-dimensional (3D) representation of a second user, wherein the asset is encrypted;
in response to determining to initiate the communication session with the second user, obtaining an encryption key from the information system; and
providing a view of the 3D representation of the second user during the communication session based on decrypting the asset using the encryption key, wherein the 3D representation of the second user is generated based at least on the asset.

20. A non-transitory computer-readable storage medium, storing program instructions executable on a device to perform operations comprising:
prior to a communication session with a second device, receiving, from an information system, an asset associated with a three-dimensional (3D) representation of a second user, wherein the asset is encrypted;
in response to determining to initiate the communication session with the second user, obtaining an encryption key from the information system; and
providing a view of the 3D representation of the second user during the communication session based on decrypting the asset using the encryption key, wherein the 3D representation of the second user is generated based at least on the asset.
